(19) United States
(12) Patent Application Publication
(10) Pub. No.: US 2007/0085994 A1
(43) Pub. Date: Apr. 19, 2007

(54) Direct print evidence

(76) Inventors: James F. Kelly, Dunwoody, GA (US); Benjamin Joel Landry, Flowery Branch, GA (US); Robert Christian Lee, Cerritos, CA (US)

Correspondence Address: Jim Kelly;President, Laser Atlanta LLC, 2927 Peterson Place, Norcross, GA, 30071, US

(21) Appl. No.: 11/247,855

(22) Filed: Oct. 12, 2005

(51) Int. Cl. G01C 3/08; G06F 3/12

(52) U.S. Cl. 356/5.02; 358/1.1; 235/462.46

(57) ABSTRACT

This invention allows a user to print from a laser measuring device (lidar) directly without the aid of a data processing intermediate. The laser measuring device (lidar) and printer communicate through any means possible. The user can modify the laser measuring device (lidar) printout through a program. This allows users to create a unique printout with information from the laser measuring device (lidar) for multiple purposes. Not only can the user print out text, information from the laser, but also control the printer's settings. By eliminating the need of a data processing unit to format information before printing, this technology eliminates the chance of data tampering from the laser measuring device (lidar). This technology will aid the police force and others by providing them with a more portable method of printing the laser measuring device (lidar) readings.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, a TABLE or a COMPUTER PROGRAM LISTING COMPACT DISK APPENDIX

Not Applicable

### BACKGROUND OF THE INVENTION

a) The Field of Endeavor

This invention pertains to anyone who is interested in printing information from the laser measuring device (lidar). It allows the user to create a custom printout to fit their needs without the aid of a data processing intermediate device.

b) Current Technique

In order to print information from the laser measuring device (lidar), there must be a data processing intermediate to interpret the information and format the printout. Currently, a message from the laser measuring device (lidar) would be sent to a PC or a PDA. A program in this data processing unit would then format the printout with the information from the laser measuring device (lidar). After creating this printout, it would then send the printout to the printer to be printed.

### BRIEF SUMMARY OF THE INVENTION

This invention allows a user to print a formatted document directly from a laser measuring device (lidar) without the need of a data processing intermediate. The laser measuring device (lidar) communicates directly with the printer using any method. The formatted document can be modified through an external program to fit any need. This allows users to create custom printouts at their convenience. Currently, all laser measuring device (lidar) printouts require a data processing intermediate to communicate with the printer. This requires additional hardware and a chance for data tampering. By eliminating this extra factor, this technology proves to be much simpler to operate and allows users to be more mobile.

### BRIEF DESCRIPTION OF THE SEVERAL VIEWS OF THE DRAWING

Not Applicable

### DETAILED DESCRIPTION OF THE INVENTION

The main objective of this invention is to allow the user to print a formatted document directly from a laser measuring device (lidar) without the aid of a data processing intermediate. The laser measuring device (lidar) communicates to the printer via any method such as bluetooth, cable, WiFi, infared, etc. The printout format can be changed and modified through an external program. Not only can the laser measuring device (lidar) print out text, but it can also send printer commands such as barcodes, pictures, etc to the printer. This would allow any user to format the printout to his or her needs.

Before this technology was available, the user must use some sort of data processing intermediate to print from a laser measuring device (lidar). The laser measuring device (lidar) would be attached to a computer or PDA that would receive, format, and print the information. This forces the user to buy additional hardware and added unnecessary complication. By eliminating the data processing intermediate, this technology allows the user to become more mobile and ensures no data tampering.

This technology can be used to the advantage of the police force. It allows the police to create a formatted evidence document that can be downloaded to the device. For example, an officer suspects a person of speeding and uses the laser measuring device (lidar) to verify that fact. He then prints this piece of evidence straight from the laser measuring device (lidar) and attaches the printout to the ticket. This ensures that no data from the laser measuring device (lidar) can been modified through an external application. At the same time, the offender would have a harder time proving the officer was lying. Using the printer commands, the officer can even encrypt the data into a barcode or other insignia to later ensure the offender has not tampered with this printout.

Since the laser measuring device (lidar) has multiple uses, this technology is not limited to the police force. Cartographers, construction workers, utility workers, etc. can use it to record information with ease. It has a broad range of uses due to the ability to reprogram the laser measuring device (lidar)'s printout.

1. What we claim as our invention is: Direct printing of any evidence data (time, date, speed, range, etc.) from the laser measuring device (lidar) to the printer via any communication method without the need of a data processing intermediate.

2. What we claim as our invention: The ability to send text, printer commands, and laser measuring device (lidar) readings from the laser measuring device (lidar) to the printer for display and printing.

3. What we claim as our invention: The ability to change the format of the printout in the laser measuring device (lidar) using a program suck that the print out is changed based on the changes made to the format in an by the laser measuring device (lidar).
